(19) United States
(12) Patent Application Publication
(10) Pub. No.: US 2011/0262092 A1
(43) Pub. Date: Oct. 27, 2011

(54) OPTIC HAVING A CLADDING

(75) Inventor: Timothy Andrew Large, Bellevue, WA (US)

(73) Assignee: Microsoft Corporation, Redmond, WA (US)

(21) Appl. No.: 13/177,416

(22) Filed: Jul. 6, 2011

Related U.S. Application Data
(63) Continuation-in-part of application No. 12/474,014, filed on May 28, 2009.

(51) Int. Cl. G02B 6/10; B32B 37/00

(52) U.S. Cl. 385/129; 156/297; 156/60

(57) ABSTRACT

Various embodiments of wedge-shaped light guide optics are disclosed. By forming a gaseous cladding layer between a wedge-shaped light guide and a turning structure, a device may be constructed that is usable to reflect and refract light for displaying an image on a display surface. By using a gas in the cladding layer, the cladding layer may have a refractive index that is lower than respective refractive indexes of each of the wedge-shaped light guide and the turning structure.

### RELATED APPLICATION

This application is a continuation-in-part of and claims priority to U.S. patent application Ser. No. 12/474,014, filed on May 28, 2009, the disclosure of which is incorporated by reference herein.

### BACKGROUND

A computer system may include one or more optical systems that provide an image as output or receive an image as input. Example optical systems include displays, cameras, scanners, and certain kinds of touch-sensitive input systems. Some optical systems may include a light guide that transmits an image to a touch-sensitive display surface, focuses an image on a detector, or does both. The light guide may be wedge-shaped, transparent in one or more visible and/or infrared wavelength ranges, and comprise at least one pair of opposing faces. Through the light guide, light of a certain wavelength range may propagate laterally, via internal reflection from the opposing faces. In many cases, the material properties and overall configuration of the light guide may affect the intensity and fidelity of the images provided by the optical system.

### SUMMARY

This document describes embodiments of an optic having a cladding. In some embodiments, the optic comprises a wedge-shaped light guide having opposing first and second faces and comprising a material having a first refractive index. The first face of the wedge-shaped light guide can support a cladding layer having a second refractive index less than the first refractive index. In some embodiments, the cladding layer may comprise a gas. The optic further comprises a turning film connected to the cladding layer via an interface layer. In an embodiment, the interface layer has a third refractive index matched to the first refractive index.

This summary is provided to introduce simplified concepts of an optic having a cladding. This summary is not meant to identify key or essential features of the claimed subject matter, nor is it intended to be used as an aid in determining the scope of the claimed subject matter.

### BRIEF DESCRIPTION OF THE DRAWINGS

Embodiments for an optic having a cladding are described with reference to the following drawings. The same numbers are used throughout the drawings to reference like features and components:

FIG. 1 shows aspects of an example computer system in which techniques for an optic having a cladding can be implemented.

FIG. 2 is a schematic, cross-sectional view showing aspects of optical system in accordance with one or more embodiments.

FIGS. 3 and 4 show aspects of an example wedge-shaped light guide in accordance with one or more embodiments.

FIG. 5 shows a multilayer turning structure in accordance with one or more embodiments.

FIG. 6 shows transmission and reflection spectra of a dichroic coating applied to a polymethylmethacrylate light guide in accordance with one or more embodiments.

FIGS. 7, 8, and 9 show ray diagrams in which light interacts with an imaging optic in accordance with one or more embodiments.

FIG. 10 shows graphs of transmission efficiency versus incidence angle for selected interfaces in accordance with one or more embodiments.

FIG. 11 shows aspects of an example input device in which techniques for an optic having a cladding can be implemented.

FIG. 12 is a schematic, cross-sectional view showing aspects of an optical system and an input zone of an input device in accordance with accordance with one or more embodiments.

FIG. 13 shows another multilayer turning structure in accordance with one or more embodiments.

FIGS. 14 and 15 show ray diagrams in which light interacts with a display optic in accordance with one or more embodiments.

FIG. 16 shows graphs of transmission efficiency versus incidence angle for selected, interfaces in accordance with one or more embodiments.

FIG. 17 shows a ray diagram in which light interacts with a display optic in accordance with one or more embodiments.

FIG. 18 illustrates an example method for making an imaging or display optic in accordance with one or more embodiments.

FIG. 19 illustrates an example method for making an imaging or display optic in accordance with one or more embodiments.

FIG. 20 shows an example application system to enable a cladding to be applied to a wedge-shaped light guide in accordance with one or more embodiments.

FIG. 21 shows a graph of transmitted power as a function of angle for an air gap produced by printed spacer dots in accordance with one or more embodiments.

### DETAILED DESCRIPTION

This document describes subject matter by way of example and with reference to certain illustrated embodiments. Components that may be substantially similar in two or more embodiments are identified coordinately and are described with minimal repetition. It will be noted, however, that components identified coordinately in different embodiments may be at least partly different. It will be further noted that the drawings included herein are schematic. Views of the illustrated embodiments are generally not drawn to scale, and the aspect ratio of some drawings may be purposely distorted for purposes of discussion of selected features or relationships.

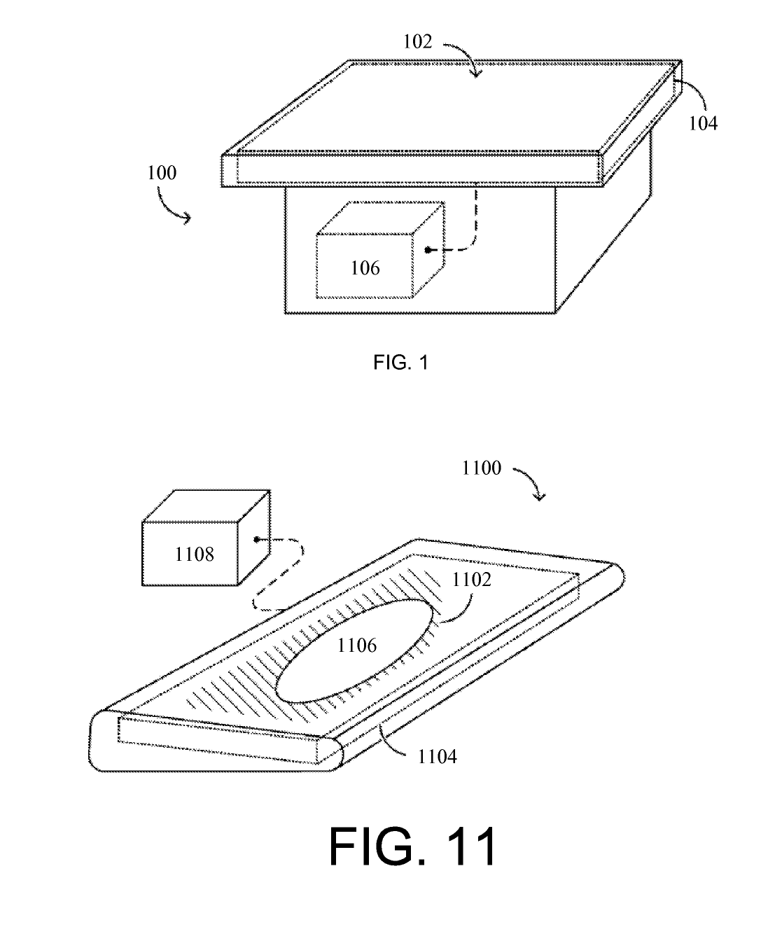

FIG. 1 shows aspects of an example computer system 100 in which techniques for an optic having a cladding can be implemented. The computer system includes a large-format, touch-sensitive display surface 102. Optical system 104, located below the touch-sensitive display surface, may be configured to provide both display and input functionality for the computer system. Accordingly, FIG. 1 shows controller 106 operatively coupled to the optical system 104. The controller 106 may be any device configured to provide display data to and receive input data from the optical system 104. In some embodiments, the controller 106 may comprise all or part of a computer; in other embodiments, the controller 106 may be any device operatively coupled to a computer via a wired or wireless communications link.

To provide display functionality, optical system 104 may be configured to project a visible image onto the touch-sensitive display surface. To provide input functionality, the optical system 104 may be configured to capture at least a partial image of objects placed on the touch-sensitive display surface—fingers, electronic devices, paper cards, food, or beverages, for example. Accordingly, the optical system 104 may be configured to illuminate such objects and to detect the light reflected from the objects. In this manner, the optical system 104 may register the position, footprint, and other properties of any suitable object placed on the touch-sensitive display surface.

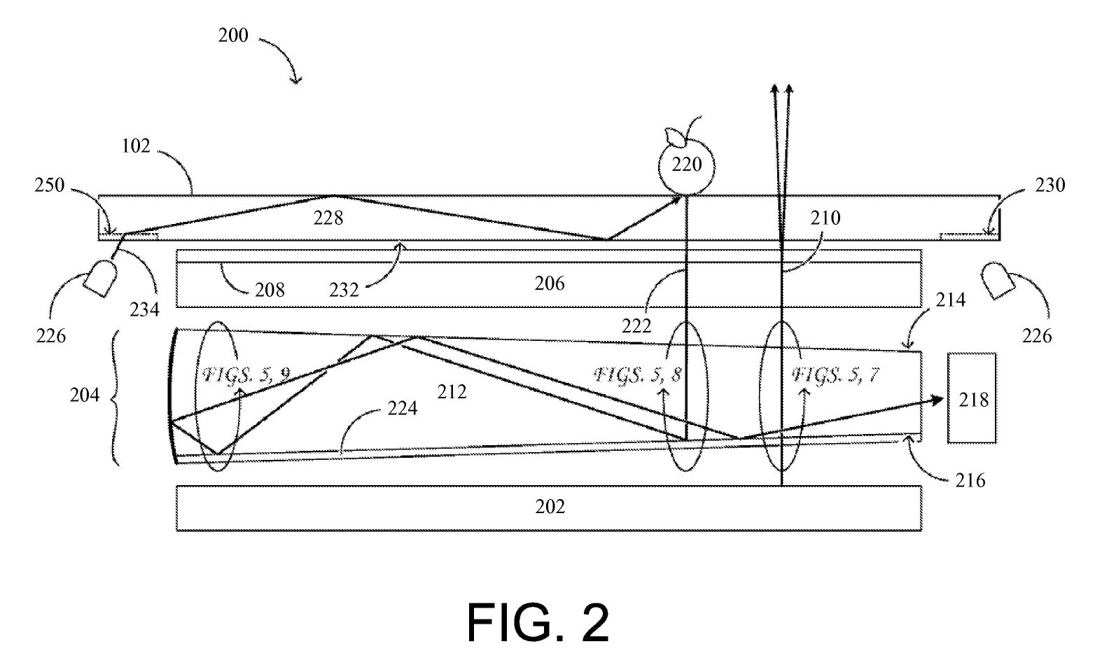

FIG. 2 is a schematic, cross-sectional view 200 showing aspects of optical system 104 in accordance with one or more embodiments. The optical system 104 includes backlight 202, imaging optic 204, light valve 206, and diffuser 208. The backlight 202 and light valve 206 may be operatively coupled to controller 106 and configured to provide a visual display image to touch-sensitive display surface 102.

Backlight 202 may be any illuminant configured to emit visible light. Light from the backlight 202 (light ray 210, for example) is projected through imaging optic 204 and is modulated with respect to color and intensity by numerous light-gating elements of light valve 206. In some embodiments, the light valve 206 may comprise a liquid-crystal display device, but other light-modulating devices may be used as well. In this manner, the backlight 202 and the light valve 206 may together generate a display image. The display image is projected through diffuser 208 and is thereby provided to touch-sensitive display surface 102. To ensure adequate display-image intensity, the imaging optic 204 and the diffuser 208 may be configured to transmit a substantial portion of the visible light incident upon them, at least in a direction normal to the touch-sensitive display surface 102, from which direction the display image would typically be viewed.

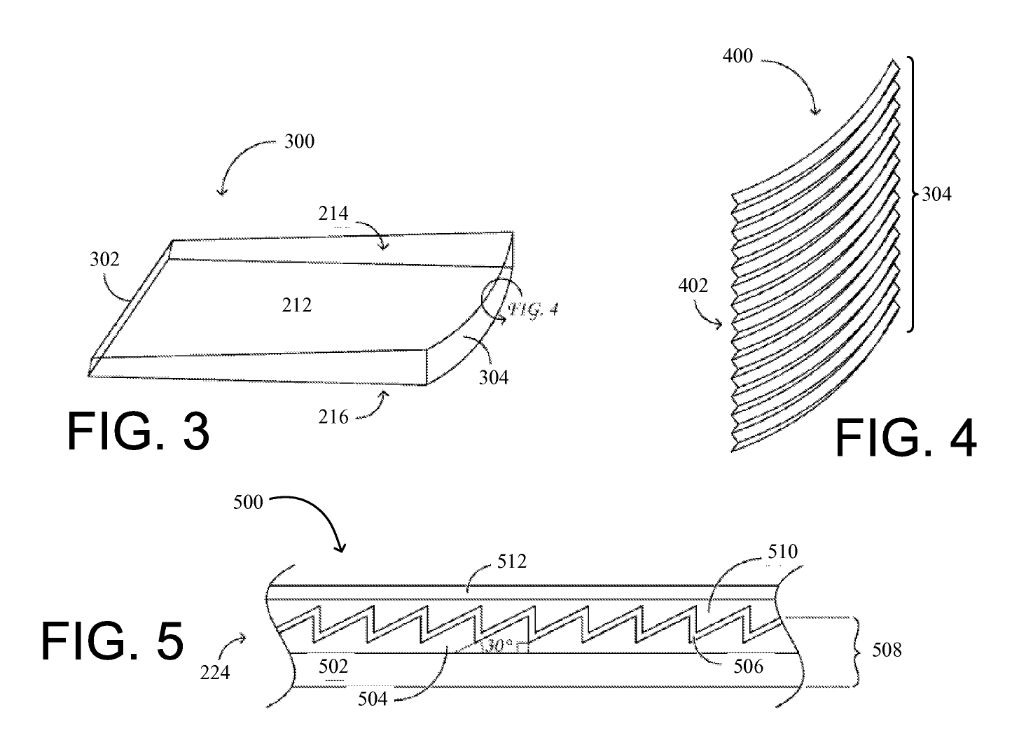

In addition, FIG. 2 shows imaging optic 204 including a wedge-shaped light guide 212 having an upper face 214 and a lower face 216. An example wedge-shaped light guide 212 is shown in greater detail in FIG. 3 at 300. It will be understood, however, that no aspect of FIG. 3 is intended to be limiting; numerous wedge-shaped light guide variants are contemplated.

Referring now to FIG. 3, the opposing upper and lower faces 214, 216, respectively, of the wedge-shaped light guide 212 may, in some embodiments, be substantially planar and nearly parallel, but offset from each other by a wedge angle of 1° or less. In one embodiment, the wedge angle may be 0.72 degrees, for example. As used herein, a ‘substantially planar’ surface is one that broadly conforms to a plane when surface roughness and manufacturing anomalies are not considered. For example, in one embodiment, a substantially planar surface may have a roughness of 3 nanometers (roughness average) or less. The wedge-shaped light guide 212 may be oriented symmetrically with respect to the horizontal and/or any plane parallel to touch-sensitive display surface 102. Therefore, the angle of intersection between the upper or lower face of the light guide and any plane parallel to the touch-sensitive display surface may be one-half the wedge angle. Accordingly, the phrases ‘normal to the wedge-shaped light guide,’ ‘normal to the imaging optic,’ and ‘normal to the opposing faces,’ etc., are used herein to indicate an orientation substantially normal to the touch-sensitive display surface 102.

Wedge-shaped light guide 212 has a thinner side 302, and an opposing thicker side 304. In the example illustrated in FIG. 3, the wedge-shaped light guide 212 is milled on the thicker side 304 to define a section of a sphere enclosed by an acute central angle. The radius of curvature of the section so defined may be determined based on the detailed configuration of optical system 104, in which the wedge-shaped light guide 212 is to be installed. In one embodiment, the thicker side 304 is approximately twice the thickness of the thinner side 302, and the radius of curvature of the thicker side 304 is approximately twice the length of the wedge-shaped light guide 212. In some embodiments, one or more sides of the wedge-shaped light guide 212 (e.g., thinner side 302 or thicker side 304) may function as a lens, wherein the radius of curvature defines a focal length of the lens.

A more-detailed sectional view of thicker side 304 in one, non-limiting embodiment is shown in FIG. 4 at 400. For example, FIG. 4 shows an array of substantially planar facets 402 running horizontally along the thicker side 304 of the wedge-shaped light guide 212. The facets 402 define a series of horizontal ridges that extend to meet the upper and lower faces of the thicker side 304. The facets 402 may be coated with a reflective material to form an interleaved reflector on the thicker side 304. The interleaved reflector so formed may serve various functions in the optical system 104 in which the light guide is to be installed, such as directing an image from a projector or onto a detector 218, for example. In one, non-limiting example, twenty-seven facets 402 may be formed in the thicker side 304 of the wedge-shaped light guide 212, forming a series of horizontal ridges spaced about 840 microns apart and extending about 80 microns from the upper or lower face of the thicker side 304. In other examples, the thicker side 304 of the wedge-shaped light guide 212 may have any other suitable shape or profile. Based on a wedge-shaped light guide 212 as described herein, imaging optic 204 may be configured to transmit light laterally between the opposing first and second faces at least partly via total internal reflection (TIR) from a boundary of the wedge-shaped light guide 212. Note that the details of the configuration described here and in FIG. 3 are presented for the purpose of example, and are not intended to be limiting.

Returning now to FIG. 2, optical system 104 may be further configured to provide input functionality to computer system 100, from FIG. 1. Accordingly, the illustrated optical system 104 includes detector 218. The detector 218 may be a camera, such as an infrared-sensitive, digital camera. Imaging optic 204 may be configured to direct onto the detector 218 light from one or more objects arranged on or contacting touch-sensitive display surface 102. Such light may originate from various sources, as described hereinafter. Accordingly, the detector 218 may capture at least a partial image of the one or more objects.

In addition, FIG. 2 shows object 220 in contact with touch-sensitive display surface 102, and light ray 222 propagating away from the object 220. The illustrated light ray 222 is shown passing through various components of optical system 104 and into imaging optic 204. To image light from the touch-sensitive display surface 102 onto detector 218, the imaging optic 204 may be configured to turn the light from light ray 222 towards the reflective thicker side 304 of the wedge-shaped light guide 212 and to confine the turned light en route to the detector 218 via total internal reflection. In this example, the light is turned at the lower face 216 of the imaging optic 204, which comprises a multilayer turning structure 224. Numerous variants of the multilayer turning structure 224 are contemplated. For example, the multilayer turning structure 224 may be reflective, to enable light to be directed back through wedge-shaped light guide 212.

FIG. 5 shows a more-detailed view of multilayer turning structure 224 in an embodiment at 500. The multilayer turning structure 224 includes base layer 502. In some embodiments, the base layer 502 may be a 300 micron-thick layer of polyethylene tetraphthalate (PET), for example. In other embodiments, the base layer 502 may comprise any other suitable material at any suitable thickness. On top of the base layer is disposed a patterned layer 504 having a regular prismatic structure in which one face of each prism is orthogonal to the base layer 502, and an adjacent face is oriented oblique to the base layer 502. The adjacent face oriented oblique to the base layer may be oriented between 15 and 45 degrees from the base layer 46—28 degrees, for example. The patterned layer 504 may comprise an acrylic copolymer, for example, or any other of a variety of suitable materials. In one embodiment, base layer 502 and patterned layer 504 may be provided in the form of a commercially prefabricated, multilayer film. For example, an image-directing film (IDF) manufactured by 3M Corporation of Saint Paul, Minn. is one example of a suitably configured, two-layer film that may be used for the base layer 502 and the patterned layer 504. On top of the patterned layer 504 is disposed a reflective layer, which includes a reflective or partly reflective coating such as, for example, dichroic coating 506.

Dichroic coating 506 may comprise a plurality of very thin dielectric layers applied to patterned layer 504 in any suitable manner. In one embodiment, the dichroic coating may be applied via evaporation or sputtering of various inorganic oxides or other materials onto the patterned layer 504, by chemical vapor deposition, or in any other suitable manner. In one embodiment, the thin dielectric layers may be quarter wave coatings of alternating high and low refractive indices—six to eight layers, for example.

Taken together, base layer 502, patterned layer 504, and dichroic coating 506 comprise turning film 508. In some examples, one or more constituents of the turning film 508 may be chosen to have a coefficient of thermal expansion similar to that of the wedge-shaped light guide 212, such that nominal temperature variations do not cause the turning film 508 to deform or separate from the wedge-shaped light guide 212. As described hereinafter, the turning film 508 may be prepared separately and bonded to the remaining layers of the multilayer turning structure 224 via an interface layer. Further, in some embodiments, the interface layer may comprise adhesive layer 510, which is disposed on the turning film 508. The adhesive layer 510 may be a polyacrylic and/or ultraviolet-curable adhesive, for example, such as Dymax 3091 or Dymax 3099, available from the Dymax Corporation of Torrington, Conn. The adhesive layer 510 serves to bond the turning film 508 to cladding layer 512, which is described in further detail below. In some embodiments, a prismatic patterned layer 504 may be sealed in an encapsulant layer and then bonded to the wedge-shaped light guide 212 using a transfer adhesive, such as Product 8154 of Adhesives Research, Inc., of Glen Rock, Pa. It will be understood that a dichroic coating 506 may be included in some turning films and omitted in others. The dichroic coating 506 may be omitted, for example, in embodiments where the imaging or display optic 204 is not configured to separate visible light from infrared light, or does so in a different manner. In turning films that lack a dichroic coating 506, a broadband reflective coating may be substituted, as further described below.

Continuing in FIG. 5, cladding layer 512 comprises a thin layer of material or gas. In some embodiments, the cladding layer 512 may be applied as a coating on wedge-shaped light guide 212, as described hereinafter. The material(s) and/or gas(es) forming the cladding layer 512 may be chosen in view of certain physical properties. First, the cladding layer 512, at least in the thickness ranges set forth below, may be substantially non-absorbing and substantially non-scattering to light that imaging optic 204 is configured to transmit. Second, the cladding layer 512 may be substantially resilient to expansion and compression strain, such that nominal temperature variations do not cause the cladding layer 512 to crack or separate from the wedge-shaped light guide 212. Third, the cladding layer 512 may have a lower refractive index than the material from which the wedge-shaped light guide 212 is formed. For example, if the wedge-shaped light guide 212 has a refractive index of 1.492, the cladding layer 512 may have a refractive index in the range 1.0 to 1.4.

Specific examples of materials that may be used for the cladding layer 512 include, but are not limited to, silicone polymers (n˜1.38) and fluoropolymers (n˜1.33). Accordingly, in some specific embodiments, the cladding layer 512 may comprise Teflon AF (EI DuPont de Nemours & Co. of Wilmington, Del.), Cytop (Asahi Corporation of Tokyo, Japan), MY-133 (MY Polymers Corporation of Rehovot, Israel), or LS-233 (Nusil Corporation of Carpinteria, Calif.), as examples. In other embodiments, the cladding layer 512 may comprise a moth-eye layer, e.g., a layer of material having a refractive index typical of optical materials (e.g., acrylic, n˜1.492), but incorporating an array of sub-wavelength features containing air. The result is a layer having a lower effective refractive index. Microporous materials such as aerogels and foams contain randomized pockets of air and can serve the same function, provided that the air pockets are substantially smaller than the wavelength of interest. Other example materials that may be used for the cladding layer 512 may include gases such as, but not limited to, air, nitrogen, oxygen, xenon, argon, helium, and so on. Gases may have a refractive index of approximately 1.00. Fourth, the cladding layer 512 may have a lower refractive index than the material from which the interface layer is formed—adhesive layer 510 in this example. Accordingly, the refractive index of the interface layer may, in some embodiments, be matched to that of the wedge-shaped light guide 212. As used herein, refractive indices are ‘matched’ if they differ by no more than ±2%. By virtue of the relative refractive indices of the cladding layer 512 and the wedge-shaped light guide 212, the imaging optic 204 may be configured to transmit light laterally between the opposing first and second faces of the wedge-shaped light guide 212 at least partly via total internal reflection from a boundary of the cladding layer 512—lower face 216, in the illustrated embodiment.

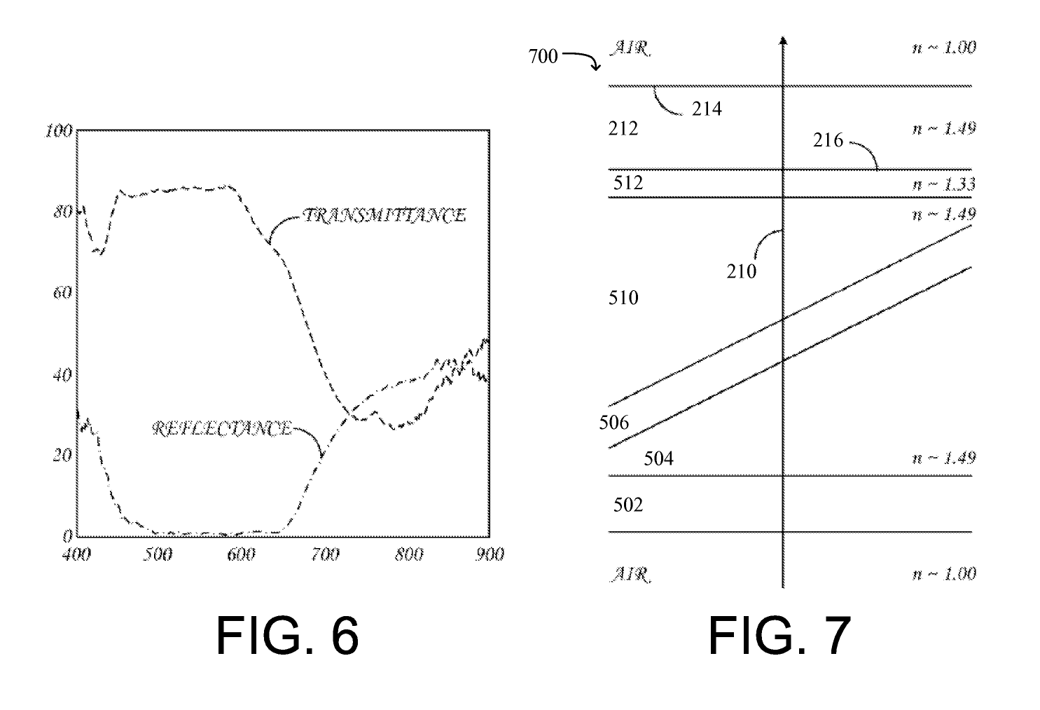

Multilayer turning structure 224 is configured to interact minimally with the light passing through the imaging optic 204 from backlight 202, such as, for example light ray 210; interaction is averted because dichroic coating 506 is substantially transparent to visible light and because light projected from the backlight 202 intersects the various interfaces of the multilayer turning structure 224 at too small an angle (measured normal to the boundary) to undergo total internal reflection. FIG. 6 shows transmission and reflection spectra of the dichroic coating 506 applied to the patterned side of an IDF film; percent transmittance/reflectance is plotted on the vertical axis, and wavelength in nanometers is plotted on the horizontal axis. The transmission spectrum (e.g., the dashed curve) reveals a relatively high transmittance in the visible wavelength range of roughly 450 to 700 nm. Further, the ray diagram 700 of FIG. 7 illustrates that visible light (e.g., light ray 210 from FIG. 2) intersecting the multilayer turning structure 224 at a suitably low incidence angle (e.g., light ray 210) may pass directly through the multilayer turning structure 224.

In contrast, multilayer turning structure 224 may interact significantly with infrared light (e.g., light ray 222 from FIG. 2) from the one or more objects 220 disposed on touch-sensitive display surface 102. Stronger interaction with infrared light is a consequence of dichroic coating 506 being substantially reflective to infrared light, as shown by the reflectance spectrum (e.g., dot-dashed curve) in FIG. 6.

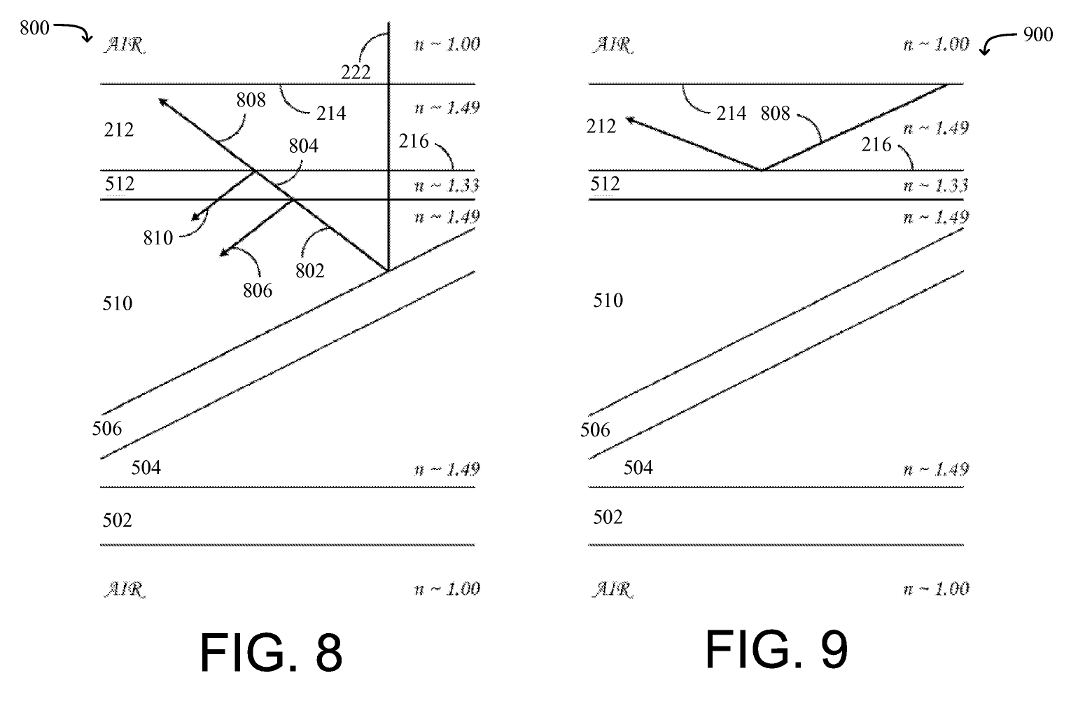

FIG. 8 shows ray diagram 800 which illustrates light ray 222, for example, entering imaging optic 204 at an angle less than the Snell's Law critical angle for any boundary through which it passes. As a result, substantially all of the light is refracted through wedge-shaped light guide 212, cladding layer 512, and adhesive layer 510. Because dichroic coating 506 is reflective to infrared light, the light ray is turned towards detector 218. Thus, FIG. 8 shows turned light ray 802 incident upon cladding layer 512.

In order for any light from object 220 to be imaged on detector 218, the light must enter imaging optic 204 via refraction through one or more interfaces. At each boundary, however, reflection may also occur. Thus, FIG. 8 shows turned light ray 802 splitting into refracted light ray 804 and reflected light ray 806. Refracted light ray 804 is further split into forward light ray 808 and an interfering light ray 810. In the embodiment illustrated in FIG. 8, the equivalent refractive indices of adhesive layer 510 and wedge-shaped light guide 212 may help to provide that the intensity of interfering light ray 810 is nearly equal to that of reflected light ray 806. Further, the phase angle separating the two rays is determined by the thickness of cladding layer 512 and by the angle at which turned light ray 802 intersects the cladding layer 512. If the phase angle is π M, where M is any odd integer, then the two light rays interfere destructively, thereby eliminating the reflected power and maximizing the forward power. As described herein, the thickness of the cladding layer 512 may be chosen to provide such a phase angle. In this manner, the imaging optic 204 may be configured to attenuate a reflection of light which is incident on a boundary of the cladding layer 512 at an angle less than a Snell's Law critical angle for the boundary (e.g., the angle measured normal to the boundary). In particular, to attenuate light having a median wavelength λ, the thickness d of the cladding layer 512 may be selected to enable the optical path through the cladding layer 512 to be approximately one-half of the median wavelength:

d≈λ/[2n₂ cos(θ)], (equation 1)

where n₂ is the refractive index of the cladding material or gas, and θ is the propagation angle relative to the interface normal. In one example, if the propagation angle is 70 degrees, the wavelength 850 nm, and the refractive index of the cladding layer 512 is 1.33, the thickness of the cladding layer 512 may be 1.9 μm. In other examples, the thickness of the cladding layer 512 may be any odd-integer multiple of the value d defined above: 3 d, 5 d, 7 d, for instance. Equation 1 is valid for any range of propagation angles below θ_{c}, the Snell's Law critical angle for total internal reflection at the interface between the wedge-shaped light guide 212 and the cladding layer 512, viz.,

θ_{c}=arcsin(n₂/n₁), (equation 2)

where n₁ is the refractive index of the material of which the wedge-shaped light guide 212 is made. However, for the purpose of selecting a suitable cladding layer thickness, the value of θ in equation 1 may be set to θ_{c}. Thus, example cladding-layer thicknesses may include

d≈Mλ/[2n₂ cos(θ_{c})], (equation 3)

where M is any odd integer. Therefore, in one, non-limiting embodiment, the resulting equation may include the following:

$$d \approx \frac{M λ}{2 {n}_{2} \sqrt{1 - {( {n}_{2} / {n}_{1} )}^{2}}} , \qquad ( equation 4 )$$

In the above-described examples, the thickness tolerance may include a percentage such as, for example, ±10 percent or ±5 percent.

On penetrating wedge-shaped light guide 212, forward light ray 808 may reach upper face 214 at greater than the Snell's Law critical angle and be reflected back to lower face 216. For example, FIG. 9 shows ray diagram 900 which illustrates the forward light ray 808, from FIG. 8, intersecting cladding layer 512 at greater than the critical angle and being internally reflected towards detector 218. After numerous internal reflections, light from object 220 may exit the imaging optic 204 and be imaged by the detector 218.

To better appreciate some of the advantages of the illustrated embodiment, it is helpful to consider an otherwise similar configuration in which no cladding layer is disposed on wedge-shaped light guide 212. For instance, the wedge-shaped light guide 212 may be disposed proximate a suitable turning structure 224. Such a configuration may enable the basic functionality described above, but may suffer at least three, interrelated problems. First, significant image intensity may be lost due to reflection as the light enters the wedge-shaped light guide 212 from the turning structure 224. Such attenuation may decrease the signal-to-noise ratio for image detection. In particular, instead of undergoing the destructively interfering reflections described above, light from the turning structure 224 may undergo a single, intensity-stealing reflection at the lower boundary of the wedge-shaped light guide 212. As a result, significant forward power may be lost, thereby reducing the intensity of the image provided to the detector 218. Second, the attenuation of the forward light ray may be sensitive to the polarization state of the incident light. This effect may result in undesirable variations in image intensity depending on the geometric and materials properties of the objects being imaged. Third, if the reflected light should somehow re-enter the wedge-shaped light guide 212 at a different location or incidence angle, the detector 218 may register a ghost image superposed on the desired image.

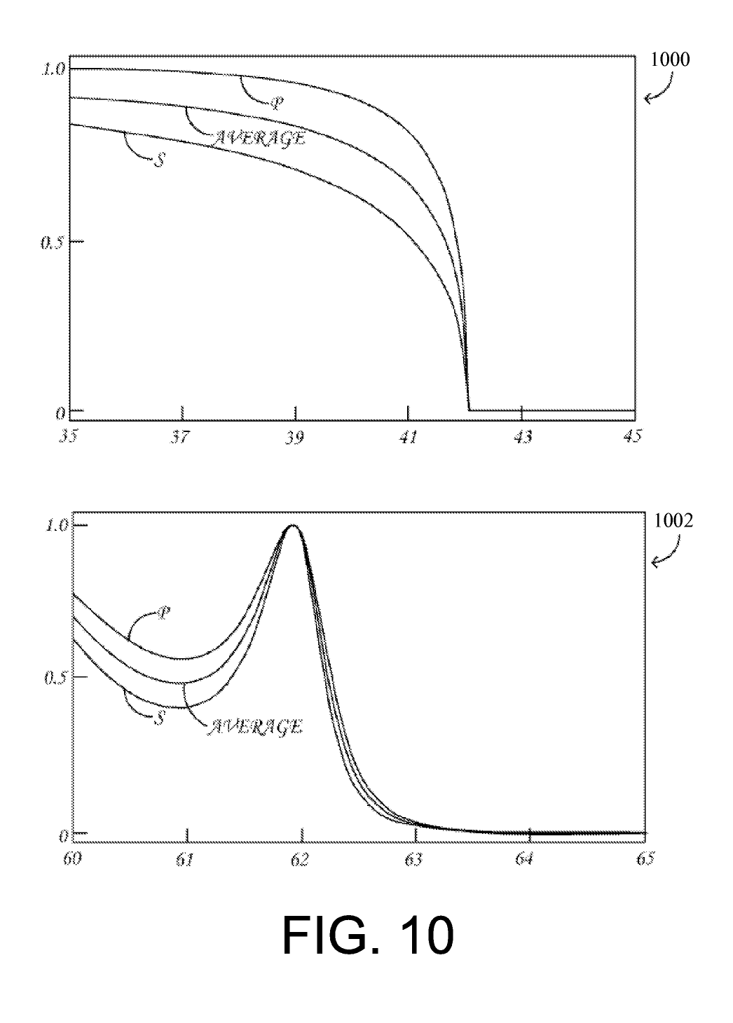

Providing a cladding layer 512 of controlled thickness sandwiched between two higher-index regions addresses each of the deficiencies identified above. The advantages this structure are further underscored with reference to FIG. 10, which shows two graphs of transmissivity through a light guide boundary as a function of incidence angle. Upper graph 1000 is for an unclad light guide (PMMA, n=1.49); lower graph 1002 is for the same light guide clad with a ca. 3.5 wavelength-thick layer of Nusil LS2233 (n=1.33), and a layer of acrylic adhesive (n=1.49) disposed over the cladding layer 512. Transmissivity was probed using 550 nm light of S and P polarization states. These graphs demonstrate that the sandwiched cladding layer 512 increases overall transmissivity by reducing reflectivity, and further reduces the polarization sensitivity of the transmissivity relative the unclad light guide boundary.

As noted above, light from one or more objects 220 disposed on the touch-sensitive display surface 102 may originate from various sources. In one embodiment, the light may be emitted by the objects 220. In the embodiment illustrated in FIG. 2, however, the light is provided by diffuse illumination of the objects 220, and reflected back through the touch-sensitive display surface 102. Thus, FIG. 2 shows infrared emitters 226 (e.g., infrared light-emitting diodes) and illuminating light guide 228. In the configuration illustrated in FIG. 2, the illuminating light guide 228 is configured to illuminate the one or more objects 220 from behind the touch-sensitive display surface 102. The illuminating light guide 228 may be any optic configured to admit infrared light from one or more entry zones 230 and to project at least some of the infrared light from exit zone 232. The entry and exit zones 230, 232 of the illuminating optic may each comprise a turning film or other turning structure. In order to admit light from the infrared emitters and simultaneously provide the desired light-turning function, the turning structures associated with the entry zone 230 and the exit zone 232 may be oriented differently from each other. Further, the exit zone 232 may comprise a low-angle diffuser film, such as product ADF-0505 manufactured by FusionOptix of Woburn, Mass. The low-angle diffuser film may be included in order to couple out the light incident on display surface 102 at a grazing angle, to prevent such incident light from being imaged by imaging optic 204. More specifically, light from the LED array may be trapped by TIR in the illuminating light guide 228; weak diffusion by the low-angle diffuser film causes the ray angles to be scattered within the illuminating light guide 228. At each interaction, some light passes the TIR angle and escapes. Although the light may escape half from the top and half from the bottom, only the light escaping from the top is used to illuminate objects.

FIG. 2 shows infrared light ray 234, for example, entering illuminating light guide 228 through entry zone 230, being turned via a turning structure of the entry zone 230, and undergoing an internal reflection at a boundary of the illuminating light guide 228. The internal reflection is a consequence of the illustrated light ray intersecting the boundary at an angle greater than the Snell's Law critical angle. Continuing forward, the illustrated light ray interacts with the turning structure of exit zone 232, and is reflected substantially upward from the exit zone 232. At least some of the illustrated light ray is now transmitted through the boundary of the illuminating light guide 228, instead of being totally internally reflected; this is because the illustrated light ray now intersects the boundary at an angle less than the critical angle.

In the embodiment illustrated in FIG. 2, exit zone 232 of illuminating light guide 228 is planar and substantially parallel to touch-sensitive display surface 102. In this configuration, light projected from the exit zone 232 passes through diffuser 208 and may illuminate object 220, which is in contact with the touch-sensitive display surface 102. It will be understood however, that numerous other illumination configurations are contemplated.

FIG. 11 shows aspects of an example input device 1100 in one embodiment. The input device 1100 includes input zone 1102, where user input is received. User input may be received via a touch-sensitive area of the input zone (a virtual keypad, mouse pad, or control pad, for example), and/or a mechanical keyboard. Optical system 1104, located behind the input zone 1102, may be configured to provide input and/or input-guiding functionality to the input zone 1102. Accordingly, the optical system 1104 is operatively coupled to controller 1116. While FIG. 11 shows the controller 1116 outside of the input device 1100 (e.g., such that the input device 1100 is controlled by a computing device to which the input device 1100 is attached), it will be understood that the controller 1116 may be integrated into the input device 1100 in at least some embodiments. In one embodiment, the optical system 1104 may be configured to illuminate all or part of the input zone 1102 and to detect light reflected from objects placed on the input zone 1102, substantially as described hereinabove with reference to touch-sensitive display surface 102. In other embodiments, however, the input functionality of the input zone 1102 may be enabled independent of the optical system 1104—via a capacitive or resistive touch screen and/or mechanical key switches, for example.

As illustrated in FIG. 11, input zone 1102 may include image-adapted area 1106. The image-adapted area 1106 is an area on which one or more changeable images (e.g., keyfaces, dials, slide-bar controls, etc.) may be displayed for the purpose of guiding user input. Accordingly, optical system 1104 may be configured to display one or more changeable images on the image-adapted area, and thereby provide input-guiding functionality to the input zone 1102. In other embodiments, the image-adapted area may occupy multiple, non-overlapping regions of the input zone 1102, or it may coincide with the entire input zone 1102.

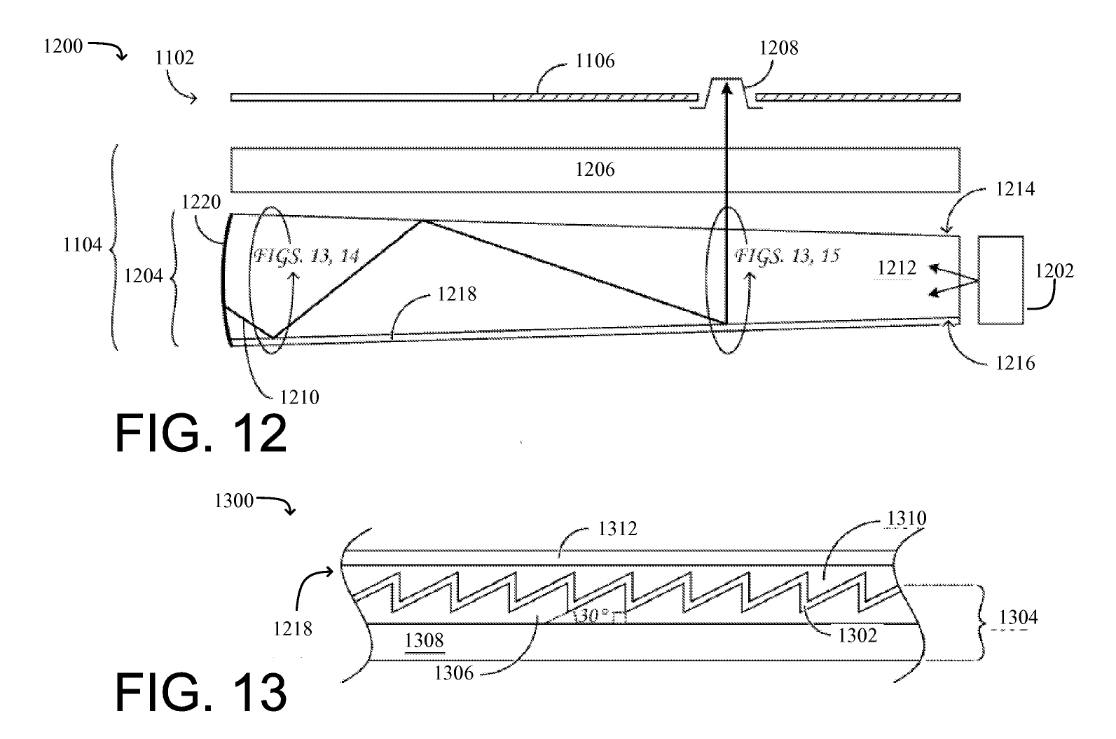

FIG. 12 is a schematic, cross-sectional view showing aspects of optical system 1104 and input zone 1102 in one embodiment. The optical system 1104 includes side-mounted light source 1202, display optic 1204, and light valve 1206; the input zone 1102 includes partly transparent keyface 1208 disposed within image-adapted area 1106.

As described above, the light valve 1206 may be any image-forming, light-gating device (e.g., a liquid-crystal display device). Side-mounted light source 1202 may be any illuminant configured to provide suitably intense, divergent light over a suitably broad visible wavelength range. As illustrated in FIG. 12, light from the side-mounted light source (e.g., light ray 1210) is projected through display optic 1204 and is modulated by numerous light-gating elements of light valve 1206 to provide a modulated image to image-adapted area 1106, and specifically, to keyface 1208.

Taken together, side-mounted light source 1202 and light valve 1206 constitute an image-creating subsystem in one example embodiment. The image-creating subsystem may be adapted to create a changeable, visible image using light from a light source (e.g., side-mounted light source 1202) and to provide the changeable, visible image to keyface 1208 or elsewhere within image-adapted area 1106. Accordingly, the image-creating subsystem may be operatively coupled to controller 1116. Further, display optic 1204 may be configured to turn and project the light from the light source so that the visible image may be displayed on keyface 1208, or elsewhere within the image-adapted area 1106. A shown in FIG. 12, display optic 1204 is configured to direct the visible light through the light valve 1206 and onto the image-adapted area 1106.

In some embodiments, image-creating subsystems of other configurations may be used instead. For example, a light valve 1206 may be incorporated into a side-mounted light source 1202 so that a fully formed image is projected through display optic 1204 and onto image-adapted area 1106. In still other examples, the image may be created via a laser operatively coupled to controller 1116 and configured to raster coherent, image-modulated light into the display optic 1204.

In the embodiment illustrated in FIG. 12, it is assumed that input functionality is provided independent of optical system 1104 (e.g., via a capacitive or resistive touch screen and/or mechanical key switches). Therefore, no detector or other input-receiving device is included in the drawing. However, in some embodiments, the optical system 1104 may be further configured to provide input functionality as well, as described previously in the context of optical system 104.

To provide an image to image-adapted area 1106, display optic 1204 may be configured to transmit light via total internal reflection and to turn at least some of the light towards the image-adapted area 1106. Therefore, the display optic 1204 comprises wedge-shaped light guide 1212, having an upper face 1214 and a lower face 1216. Multilayer turning structure 1218 is disposed on the lower face 1216. In the illustrated embodiment, the wedge-shaped light guide 1212 further includes a thicker side adjacent the upper and lower faces 1214, 1216, respectively, and supporting a reflective coating 1220, and, a thinner side adjacent the upper and lower faces 1214, 1216 respectively, opposite the thicker side. Coupled to a display optic 1204 of this configuration, the image-creating subsystem may be adapted to project light for forming the image into the thinner side of the wedge-shaped light guide 1212.

FIG. 13 provides a more detailed view of multilayer turning structure 1218 in an embodiment at 1300. In one embodiment, multilayer turning structure 1218 may be substantially the same as multilayer turning structure 224 described hereinabove, but numerous variations are contemplated as well. For example, in embodiments where transmission of light normal to the display optic 1204 is not an issue, dichroic coating 506, from FIG. 5, may be replaced by a broadband reflective coating 1302. Accordingly, the embodiment illustrated in FIG. 13, shows a turning film 1304 that includes the broadband reflective coating 1302 disposed on top of patterned layer 1306, which in turn is disposed on top of base layer 1308. In one embodiment, the broadband reflective coating 1302 may be a thin layer of aluminum or a thin film of silver disposed on top of an inconel sublayer. It will be understood that the examples provided herein are not intended to be limiting, as various other reflective coatings may be suitable as well. In contrast to the previous embodiments, multilayer turning structure 1218 is configured to interact strongly with light over a broad wavelength range that includes visible and infrared regions. The multilayer turning structure 1218 may also include an interface layer (e.g., adhesive layer 1310) which serves to bond the turning film 1304 to cladding layer 1312. Cladding layer 1312 may be similar in form to cladding layer 512 in FIG. 5.

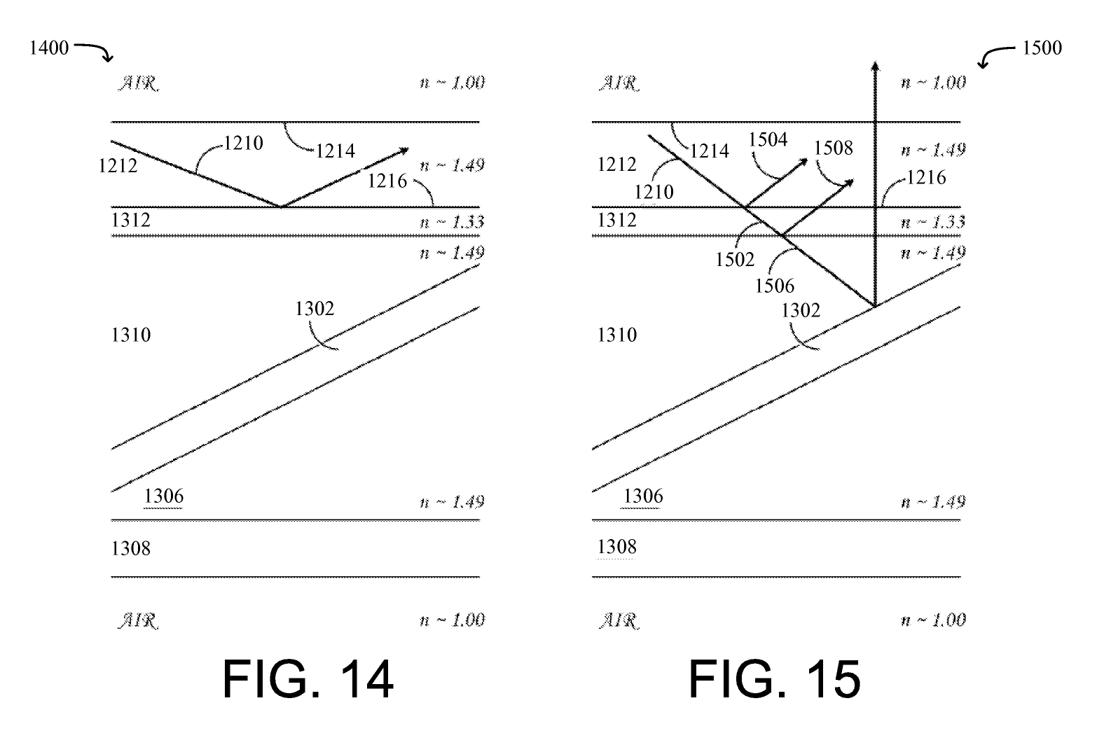

FIG. 14 illustrates a ray diagram 1400 which shows light ray 1210 entering display optic 1204 at an angle greater than the Snell's Law critical angle for the boundary between the wedge-shaped light guide 1212 and cladding layer 1312; the light ray 1210 is totally internally reflected. On reaching upper face 1214, the light ray 1210 is further reflected back to lower face 1216. As shown in ray diagram 1500 of FIG. 15, light ray 1210 may now intersect the boundary between the wedge-shaped light guide 1212 and the cladding layer 1312 at less than the critical angle and be refracted out of the light guide 1212. The light ray 1210 then reflects off broadband reflective coating 1302, projects upward through the display optic 1204, and forms an image on image-adapted area 1106 and/or on keyface 1208.

In order for any light reflected from side-mounted light source 1202 to reach image-adapted area 1106, it may exit wedge-shaped light guide 1212 via refraction. However, reflection may also occur at each boundary that the light ray intersects. Thus, FIG. 15 shows light ray 1210, from FIG. 12, splitting into a refracted light ray 1502 and a reflected light ray 1504. Refracted light ray 1502 is further split into a forward light ray 1506 and an interfering ray 1508. In the embodiment illustrated in FIG. 15, the equivalent refractive indices of adhesive layer 1310 and wedge-shaped light guide 1212 may help to provide that the intensity of interfering light ray 1508 is nearly equal to that of reflected light ray 1504. Further, the phase angle separating the two rays is determined by the thickness of cladding layer 1312 and by the angle at which light ray 1210 intersects the cladding layer 1312. The thickness of the cladding layer 1312 may therefore be chosen, as previously described, to eliminate the reflected power and to maximize the forward power.

As described above, the advantages of the embodiment illustrated in FIG. 15 may be best understood with reference to an otherwise similar configuration in which no cladding layer 1312 is disposed on the wedge-shaped light guide 1212. Such a configuration may suffer an analogous, though optically converse, set of problems. First, residual internal reflection below the critical angle of incidence may cause a significant amount of light to remain in the wedge-shaped light guide 1212, and thereby steal intensity from the exiting, forward light ray. As a result, the intensity of the image projected on image-adapted area 1106 would be attenuated. Second, the attenuation would be sensitive to the polarization state of the incident light, resulting in variations in image intensity depending on geometric and materials properties of the optical system 1104. Third, the residual internal reflection noted above would cause the light remaining in the light guide to go an extra bounce before exiting, thereby forming a ghost image superposed on the desired image.

By providing cladding layer 1312 on display optic 1204, the illustrated embodiment addresses each of the deficiencies identified above.

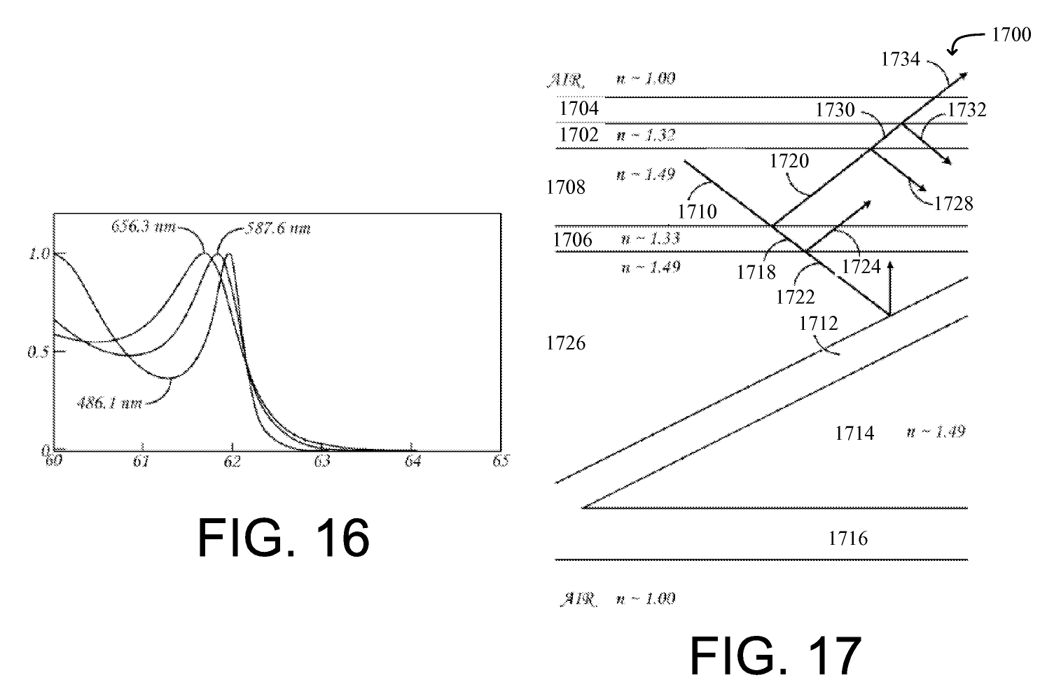

As shown in FIG. 10, both clad and unclad light guides exhibit total internal reflection of light incident on the light-guide boundary above a critical angle, and refract at least some light incident on the boundary below the critical angle. For a light guide having a thin-layer coating, however, the critical angle may depend on wavelength. In cases where the propagating light is confined to a narrow wavelength band (e.g., light from an IR-LED) this issue may not pose a significant issue. However, in applications where a light guide is used to image broad-band light, a wavelength dependence on the critical angle may lead to various undesired effects, including color distortion and projection of superposed, false-color images. Fortunately, the cladding layers described herein are found to be suitably insensitive to wavelength, as shown in the transmission spectra of FIG. 16, where transmission efficiency is plotted on the vertical axis, and incidence angle is plotted on the horizontal for wavelengths in the visible range.

In embodiments, the thin-layer cladding approach as described hereinabove may be taken a step further. In a display optic 1204 comprising a wedge-shaped light guide 1212 having opposing upper and lower faces 1214, 1216, respectively, a cladding layer 1312 may be disposed on the lower face 1216, and on the upper face 1214 as well. A potential advantage of this embodiment is now described with reference to the ray diagram 1700 of FIG. 17.

The layered structure of the display optic 1204 shown in FIG. 17 is similar to the one shown in FIGS. 14 and 15, but further includes upper cladding layer 1702 and capping layer 1704. The appropriate composition and thickness of the upper cladding layer 1702 may be substantially the same as that of cladding layer 512, described hereinabove. However, the upper cladding layer 1702 may be chosen to have a refractive index lower than that of cladding layer 1706. The capping layer 1704 may comprise any suitably transparent material having a refractive index matched to that of wedge-shaped light guide 1708.

FIG. 17 shows light ray 1710 intersecting the boundary between wedge-shaped light guide 1708 and cladding layer 1706 at less than the critical angle for the boundary. Most of the light is therefore refracted out of the light guide 1708, where it reflects off broadband reflective coating 1712 and projects upward through the display optic 1204 to form an image. The broadband reflective coating 1712, in this example, is disposed on top of a patterned layer 1714, which is disposed on top of a base layer 1716.

As indicated above, reflection may also occur at each boundary that the light ray intersects. Thus, FIG. 17 shows light ray 1710 splitting into a refracted light ray 1718 and a reflected light ray 1720. Refracted light ray 1718 is further split into a forward light ray 1722 and an interfering ray 1724. In the embodiment illustrated in FIG. 17, the equivalent refractive indices of adhesive layer 1726 and wedge-shaped light guide 1708 provide that the intensity of interfering light ray 1724 is nearly equal to that of reflected light ray 1720. Further, the phase angle separating the two rays is determined by the thickness of cladding layer 1706 and by the angle at which light ray 1710 intersects the cladding layer 1706. The thickness of the cladding layer 1706 may therefore be chosen, as described above, to attenuate the reflected power and to correspondingly increase the forward power.

As further indicated above, destructive interference between reflected light ray 1720 and interfering light ray 1724 may reduce the power of the reflected light ray 1720 to a small fraction of the forward ray (10%, for example), but reflection at this level may still be problematic for some, select applications. Therefore, FIG. 17 shows reflected light ray 1720 incident on the boundary between wedge-shaped light guide 1708 and upper cladding layer 1702. The reflected light ray 1720 now splits into returning light ray 1728 and refracted light ray 1730. Refracted light ray 1730 further splits into escaping light ray 1732 and interfering light ray 1734. The equivalent refractive indices of capping layer 1704 and wedge-shaped light guide 1708 may help to provide that the intensity of refracted light ray 1730 is nearly equal to that of interfering light ray 1734. Further, the phase angle separating the two rays is determined by the thickness of upper cladding layer 1702 and by the angle at which light ray 1710 intersects the upper cladding layer 1702. The thickness of the upper cladding layer 1702 may therefore be chosen, as described above, to eliminate the returning power and to maximize the escaping power. Accordingly, this embodiment provides not one but two stages of destructive interference, the effect of which is to further reduce the intensity of ghost images projected through the display optic.

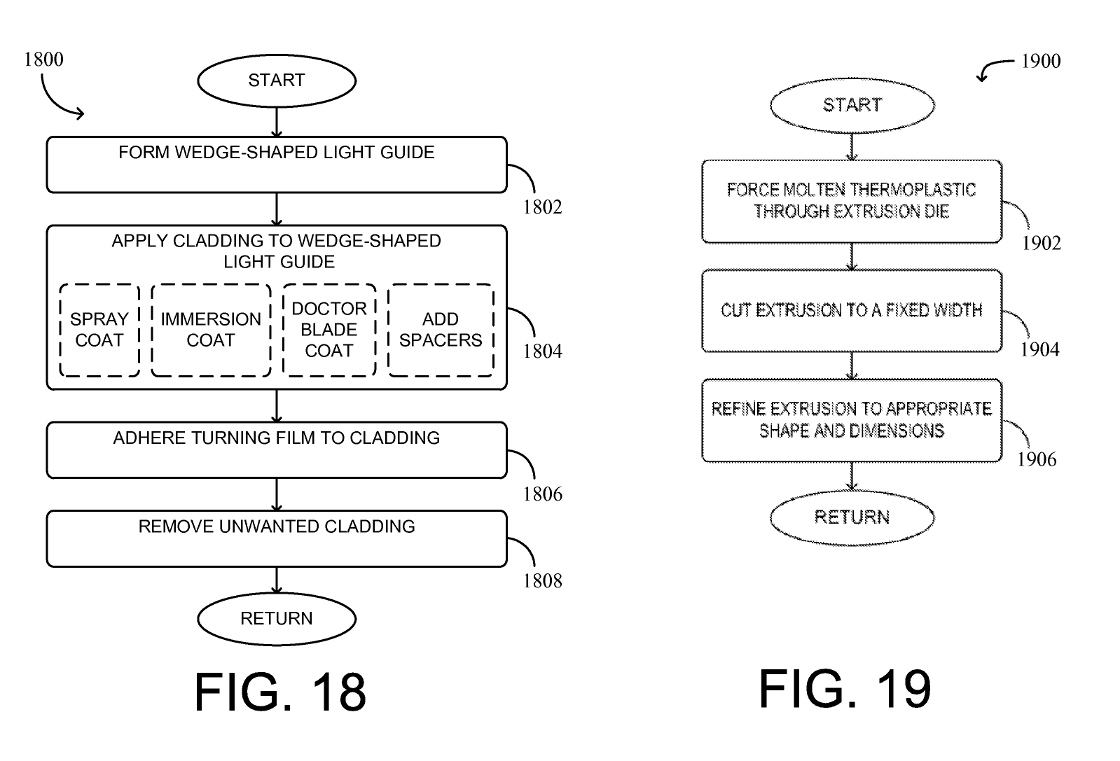

FIG. 18 illustrates an example method 1800 for making an imaging or display optic in one or more embodiments. The method begins at 1802, where a wedge-shaped light guide having opposing upper and lower faces is formed. The wedge-shaped light guide may be formed in any suitable manner. One example method for forming the wedge-shaped light guide is illustrated in FIG. 19 by method 1900.

Block 1902 in FIG. 19, forces a molten, thermoplastic polymer or other thermoplastic material through an extrusion die having a quadrilateral or other suitable cross section. The thermoplastic polymer may comprise a polyacrylate, a polyacrylonitrile, a polyamide, and/or a polycarbonate, for example. The thermoplastic material may be selected for transparency in one or more visible, ultraviolet, and/or infrared wavelength ranges. In embodiments where the light guide is to be used solely for displaying and/or collecting optical images, transparency over the visible range may be sufficient. In other embodiments, however, the thermoplastic polymer may be selected for transparency in various infrared and/or ultraviolet ranges as well. Further, the thermoplastic material may be chosen in view of its refractive index. In some embodiments, the thermoplastic material, in solid form, may have a refractive index greater than 1.4.

Forcing the molten thermoplastic polymer through a die having a quadrilateral cross-section gives rise to a substantially wedge-shaped extrusion having a pair of opposing faces and a quadrilateral cross-section. In other embodiments, the die may be shaped differently, thereby providing a differently shaped extrusion. For example, the extrusion die may be rectangular in shape and give rise to a sheet-like (e.g., rectangular prismatic) extrusion.

Continuing in FIG. 19, block 1904 cuts the cooled extrusion to one or more fixed dimensions, including but not limited to a fixed width. The extrusion may be cut by using a saw or a mill. The dimensions to which the extrusion is cut may be chosen based on the dimensions of the display device in which the light guide is to be installed.

Block 1906 refines the cut extrusion to an appropriate shape and to appropriate dimensions for further processing. In some embodiments, the appropriate shape may be similar to the final shape of the light guide that is desired, and the appropriate dimensions may be the same as or slightly larger than the desired final dimensions. Refining the extrusion may comprise machining, cutting, milling, etching, and/or polishing, as examples. Etching may comprise wet or dry mechanical etching (e.g., sanding or filing) and/or chemical etching. Any etching process may be conducted with the aid of a mask (e.g., a photomask) to vary the etching depth in a controllable manner, to introduce surface features, etc.

Refining the extrusion may also comprise modifying a cross-section of the extrusion. Thus, in some embodiments, the extrusion may have the desired wedge shape, while in other embodiments, the extrusion may have a rectangular, sheet-like shape before refinement at block 1906, where the extrusion is refined to have the desired wedge shape.

In order for the wedge-shaped light guide to transmit images with high fidelity and without undue loss, the opposing faces may be configured to be flat and smooth. In some embodiments, the methods described hereinabove may yield surfaces having adequate smoothness. In other embodiments, however, refinement at block 1906 may further comprise finely adjusting the dimensions of the wedge-shaped light guide until the desired planarity and smoothness is achieved. The dimensions may be finely adjusted via mechanical etching or polishing, as described above, via compression molding, or in any other suitable manner.

Returning now to method 1800 of FIG. 18, block 1804 applies a thin cladding layer to at least a first face of the wedge-shaped light guide. The thin cladding layer may have substantially the same properties as described for cladding layers 512, 1312, and/or 1706 of the embodiments described hereinabove. It will be understood, however, that the cladding layer may also be at least partly different. Thus, the cladding layer may have a refractive index less than that of the wedge-shaped light guide. The refractive index may be less than 1.4, for example. Further, the thickness of the cladding layer may be selected based on the wavelength range of the light to be imaged and/or displayed as described hereinabove with reference to equation 1 and the associated description.

In some embodiments, applying the cladding layer to at least the first face of the wedge-shaped light guide may comprise applying a liquid or gel-like cladding formulation to at least the first face and allowing at least some of the liquid or gel-like cladding formulation to solidify. The liquid or gel-like cladding formulation may be chosen to have, after curing, a refractive index lower than that of the wedge-shaped light guide. For example, the liquid or gel-like cladding formulation may comprise a fluoropolymer dispersion or pre-polymerized fluoropolymer precursor. Allowing at least some of the liquid or gel-like cladding formulation to solidify may comprise promoting a curing process (e.g., thermally, photochemically, etc.) as further described below. In embodiments where a polymer precursor such as a fluoropolymer precursor is included in the cladding formulation, the solidification may comprise a polymerization or oligomerization process.

In some embodiments, the liquid or gel-like cladding formulation may comprise a 100-percent-solids formulation; in other embodiments, the formulation may comprise a solvent or other vehicle to aid in dispersing the cladding material or precursor.

In these and other embodiments, the liquid or gel-like cladding formulation may include an ultraviolet-curable component. Accordingly, method 1800 may further comprise irradiating at least the first face of the wedge-shaped light guide with ultraviolet radiation to cure the ultraviolet-curable component.

Depending on the particular liquid or gel-like cladding formulation in use, various different modes of application may be used. In one embodiment, the formulation may be sprayed onto at least the first face of the wedge-shaped light guide in the form of an aerosol. In one variant of this approach, the liquid or gel-like cladding formulation may be dispersed ultrasonically during the spraying process.

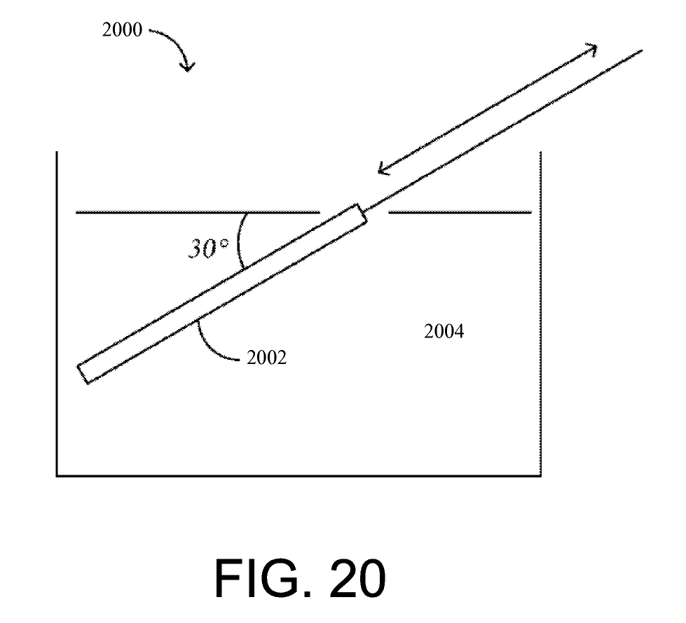

In another embodiment, applying the liquid or gel-like cladding formulation may comprise at least partly immersing the wedge-shaped light guide in the liquid cladding formulation, and, in some variants, withdrawing the wedge-shaped light guide from the liquid cladding formulation at an oblique angle with respect to a surface of the liquid cladding formulation. FIG. 20 shows an example application system 2000 to enable a cladding to be applied to a wedge-shaped light guide 212 via immersion in, followed by withdrawal from, a liquid cladding formulation 2004. The wedge-shaped light guide 2002 may be similar to wedge-shaped light guide 212 from FIG. 2 and/or wedge-shaped light guide 1212 from FIG. 12. In one embodiment, the application system 2000 shown in the drawing may be used with a liquid cladding formulation 2004 comprising a 2.5 percent solution of MY-133MC (a product of MY Polymers), dissolved in a suitable solvent. Suitable solvents include parachlorobenzotrifluoride (PCBTF), HFE-7100 (a product of 3M Corporation of Saint Paul, Minn.), and Oxol-100 (a product of Halliburton Corporation of Houston, Tex.), for example.

After immersion in the cladding formulation 2004, the wedge-shaped light guide 212 may be withdrawn at an oblique angle with respect to the surface of the liquid cladding formulation (e.g., 30 degrees) using a controlled-velocity, motorized lift. In this embodiment, the curing of the cladding layer may occur following, or at least partly during, the withdrawal process. In some embodiments, immersion, withdrawal, and curing may each be enacted once to provide a cladding layer of the desired thickness. In other embodiments, repeated immersion and curing may be used to attain the desired thickness.

In yet another embodiment, applying the liquid or gel-like cladding formulation 2004 may comprise applying the cladding formulation 2004 to the first face of the wedge-shaped light guide 212 in a fixed-thickness layer by dragging a doctor blade along and at a fixed distance above the first face.

In embodiments, applying the cladding layer may include applying an array of spacers to either the first face of the wedge-shaped light guide or a first face of the turning structure, or both. The spacers in the array may include sparsely arranged spacers having substantially uniform height and configured to support the cladding layer structure such that the cladding layer may be formed substantially of a gas and may have a thickness defined at least in part by the height of the spacers. In embodiments, the thickness of the cladding layer may be defined by a function of the spacer height where the spacer height is greater or lesser than the thickness of the cladding layer. For example, one or more additional materials or layers (e.g., adhesive layer) may be joined to the first face of the wedge-shaped light guide or the first face of the turning structure, or both, and the spacers may be partially embedded in the additional material(s) or layer(s), effectively reducing the thickness of the cladding layer to a thickness that is less than the spacer height. With respect to the gas in the cladding layer any suitable gas may be used, such as air, nitrogen, oxygen, argon, xenon, helium, and so on. In addition, any suitable spacer technique may be used to apply the array of spacers including, but not limited to, spacer beads deposited from volatile fluid suspension, spacer rods deposited from suspension, lithographically created pillars, printed dots, and so on.

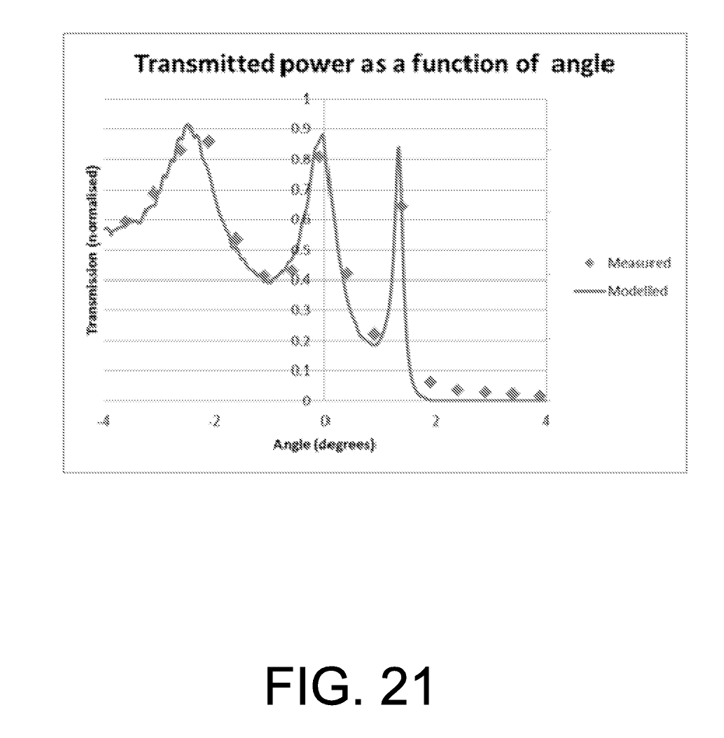

Printed dots, for example, may be applied using a controlled precision ink-jet printing process that is configured to print dots of sufficient optical density and uniformity to act as spacers. FIG. 21 shows transmission measurements on a sample in which spacer dots were created by ink jet printing. As shown in FIG. 21, the gaseous cladding layer supported by the printed dots is a function of the dot height. Further, the transmission is measured as a function of angle against the theory curve which, in this example, assumed a 2.4 um dot height. In addition, gases may have a refractive index of approximately 1.00, which allows for the refractive index of the gaseous cladding layer to be lower than the refractive index of the wedge-shaped light guide.

Continuing with method 1800 of FIG. 18, block 1806 adheres a turning film to the cladding layer via an interface layer. The turning film may comprise a prismatic patterned film to which broadband or dichroic reflective coating is applied, as described above. Applying the turning film via the interface layer may comprise applying an adhesive layer to one or both of the cladding layer and the turning film. The adhesive may be chosen such that the refractive index of the cured adhesive layer (e.g., the interface layer) is matched to that of the wedge-shaped light guide. The turning film may then be compressed against the cladding layer. In some embodiments, the adhesive may be a thermally curing resin (e.g., an epoxy/amine resin). In other embodiments, the adhesive may be air- or moisture-curing. In still other embodiments, the adhesive may be ultraviolet-curing (e.g., an ultraviolet-curing, acrylic resin). Accordingly, method 1800 may further comprise irradiating at least the first face of the optic with ultraviolet light to cure the adhesive layer.

In embodiments utilizing a gaseous cladding layer, spacers can prevent collapse of the cladding layer. Expansion of the thickness of the cladding layer, however, may be possible. Expansion of the thickness of the gaseous cladding layer may be prevented or reduced in various manners. Some examples include applying vacuum, applying plasma discharge to charge the surfaces to enable the surfaces to stick together, evaporating a thin layer of adhesive material to adhere the surfaces, constructing the device and the cladding layer to both be clad globally slightly convex to enable residual stress to close the gap, and so on.

Block 1808 removes unwanted cladding layer from the wedge-shaped light guide. The unwanted cladding layer may be removed by, for example, chemical or mechanical etching, adhering a sticky film to the cladding layer and then lifting it off, or in another suitable manner.

It will be understood that some of the process steps described and/or illustrated herein may in some embodiments be omitted without departing from the scope of the above-described features and methods. Likewise, the indicated sequence of the process steps may not always be required to achieve the intended results, but is provided for ease of illustration and description. One or more of the illustrated actions, functions, or operations may be performed repeatedly, depending on the particular strategy being used.

Finally, it will be understood that the systems and methods described herein are exemplary in nature, and that these specific embodiments or examples are not to be considered in a limiting sense, because numerous variations are contemplated. Accordingly, the present disclosure includes all novel and non-obvious combinations and sub-combinations of the various systems and methods disclosed herein, as well as any and all equivalents thereof.

What is claimed is:

1. A device comprising:
a display surface configured to display an image using light from a light source;
the light source configured to generate the light used for displaying the image on the display surface;
a wedge-shaped light guide formed from a material having a first refractive index and configured to allow the light to pass through from the light source to the display surface; and
a turning structure comprising multiple layers, the multiple layers including:
a reflective layer configured to reflect light toward the wedge-shaped light guide;
an interface layer having a second refractive index that is similar to the first refractive index; and
a cladding layer interposed between the wedge-shaped light guide and the interface layer, the cladding layer comprising a gas with a third refractive index that is lower than the first refractive index and the second refractive index, the cladding layer having a thickness.

2. The device of claim 1, wherein the device is configured to reflect and refract light to enable an image to be formed on the display surface and reduce an intensity of a ghost image on the display surface.

3. The device of claim 1, wherein the thickness of the cladding layer is defined by one or more spacers joined with the wedge-shaped light guide and the interface layer of the turning structure.

4. The device of claim 3, wherein the one or more spacers comprise one of spacer beads, spacer rods, lithographically created pillars, or printed dots.

5. The device of claim 3, wherein the one or more of spacers include printed dots printed with a precision ink-jet printing process.

6. The device of claim 1, wherein the reflective layer comprises a dichroic coating.

7. The device of claim 1, wherein the gas in the cladding layer comprises air.

8. The device as recited in claim 1, wherein the device is further configured to produce a sharp angular switch between total internal reflection within the wedge-shaped light guide and transmission from the wedge-shaped light guide into the turning structure, the turning structure being substantially insensitive to wavelength of the light.

9. The device of claim 1, wherein the cladding layer comprises opposing first and second boundaries, the first boundary configured to split an incoming light ray into a refracted light ray and a reflected light ray, and the second boundary configured to split the refracted light ray into a forward light ray and an interfering light ray.

10. The device of claim 9, wherein the reflected light ray and the interfering light ray differ by a phase angle, the phase angle being defined by the thickness of the cladding layer and an angle at which the incoming light ray intersects the first boundary.

11. The device of claim 10, wherein the reflected light ray and the interfering light ray destructively interfere with one another based on the phase angle.

12. A method comprising:
forming a cladding layer on a face of a wedge-shaped light guide or an interface layer of a turning structure, the cladding layer including a gas having a first refractive index that is lower than a second refractive index of the wedge-shaped light guide and a third refractive index of the interface layer of the turning structure; and
joining the turning structure to the wedge-shaped light guide to construct an optical device where the cladding layer is disposed between the face of the wedge-shaped light guide and the interface layer of the turning structure, the turning structure configured to reflect light through the cladding layer toward the wedge-shaped light guide.

13. The method of claim 12, wherein forming the cladding layer further comprises applying an array of spacers onto the face of the wedge-shaped light guide or onto the interface layer of the turning structure.

14. The method of claim 13, wherein respective spacers in the array of spacers are configured to support a structure of the cladding layer and define a thickness of the cladding layer based at least in part on a height of the respective spacers.

15. The method of claim 13, wherein the gas in the cladding layer is disposed throughout the cladding layer and proximate to respective spacers in the array of spacers.

16. The method of claim 12, further comprising joining the optical device with a display surface to enable display of an image on the display surface via reflection and refraction through the cladding layer and the wedge-shaped light guide, wherein an intensity of a ghost image projected through the optical device is reduced through the reflection and refraction of the light through the cladding layer and the wedge-shaped light guide.

17. An optical device comprising:
a light guide formed in a wedge shape;
a turning film disposed proximate to a face of the light guide;
a gap filled with a gas and forming a cladding layer interposed between the face of the light guide and the turning film, the cladding layer comprising first and second opposing sides each configured to reflect at least a portion of a light ray passing through the cladding layer toward the light guide or the turning film; and
an array of spacers located within the gap, the array of spacers arranged to maintain a gap thickness that is configured to determine a phase angle between a first reflected portion of the light ray and a second reflected portion of the light ray, the phase angle being effective to cause destructive interference between the first and second portions of the light ray.

18. The optical device of claim 17, wherein the array of spacers includes spacers comprising printed dots.

19. The optical device of claim 17, wherein the phase angle is configured to cause reduction of a reflected power of the light ray and an increase of a forward power of the light ray.

20. The optical device of claim 17, wherein the light ray passing through the cladding layer is split at the first opposing side into a refracted light ray and a reflected light ray, and the refracted light ray is split at the second boundary into a forward light ray and an interfering light ray.
